(19) United States
(12) Patent Application Publication
(10) Pub. No.: US 2024/0214185 A1
(43) Pub. Date: Jun. 27, 2024

(54) PROTECTING SECRET PROCESSING, SECRET INPUT DATA, AND SECRET OUTPUT DATA USING ENCLAVES

(71) Applicants: LI Zhiqiang, Beijing (CN); Daniel MIDDLETON, Orono, MN (US); Dan HE, Shanghai (CN); Yiqi CHEN, Shanghai (CN); Intel Corporation, Santa Clara, CA (US)

(72) Inventors: Zhiqiang LI, Beijing (CN); Daniel MIDDLETON, Orono, MN (US); Dan HE, Shanghai (CN); Yiqi CHEN, Shanghai (CN)

(73) Assignee: Intel Corporation, Santa Clara, CA (US)

(21) Appl. No.: 18/556,022

(22) PCT Filed: Sep. 23, 2021
(86) PCT No.: PCT/CN2021/119882

§ 371 Date: Oct. 18, 2023

(51) Int. Cl. H04L 9/08

(52) U.S. Cl. CPC H04L 9/0825; H04L 9/083; H04L 9/0822

(57) ABSTRACT

An apparatus and method of protect secret input data, secret processing, and secret output data by receiving a signed private enclave from a secret processing owner; receiving a signed manager enclave from a trusted third party (TTP); deploying the signed manager enclave; receiving a protected code loader (PCL) key encrypted with an encryption public key of the signed manager enclave from the secret processing owner; deploying the signed private enclave; running secret processing in the signed private enclave with secret input data to generate secret output data; and encrypting the secret output data in the signed private enclave using an ephemeral key, encrypting the ephemeral key in the signed private enclave using an encryption public key of the signed manager enclave, and sending the encrypted secret output data and the encrypted ephemeral key to the signed manager enclave.

### CLAIM OF PRIORITY

This application claims, under 35 U.S.C. § 371, the benefit of and priority to International Application No. PCT/CN2021/119882, filed Sep. 23, 2021, titled PROTECTING SECRET PROCESSING, SECRET INPUT DATA, AND SECRET OUTPUT DATA USING ENCLAVES, the entire content of which is incorporated herein by reference.

### FIELD

Embodiments relate generally to computer security, and more particularly, to protecting secret processing, secret input data, and secret output data using enclaves in computing systems.

### BACKGROUND

Some models having algorithms embedded therein are trained during a training phase using training data to derive model parameters. These models and their algorithms often include machine learning models, deep learning models, artificial intelligence models, and other algorithms wherein a model characterized by training parameters is trained over a set of training data to determine model parameters, and the model parameters are applied to the model by an end user at a later time (e.g., for inferencing tasks) using another set of data. Sometimes one entity, sometimes called an algorithm owner, develops a secret algorithm embodied in a model, and another entity, called a data owner, provides a secret set of training data used to train the model. Once the model is trained, a user can use the model during a deployment phase to perform data processing using the user's data. The algorithm owner may want to protect the details of the algorithm's processes from exposure to the data owner and/or the user. The data owner may want to protect the secret training data used during training of the model from the algorithm owner and/or the user. Existing security mechanisms do not support the protection goals of both the algorithm owner and the data owner at the same time. Existing approaches may protect the model but assumes that the model is pre-trained and does not deter information leakage from occurring during the training phase when the training data is secret.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 is a diagram of a computing arrangement during an initialization phase according to some embodiments.

FIG. 2 is a diagram of a computing arrangement during a deployment phase according to some embodiments.

FIGS. 3A and 3B are flow diagrams of security processing according to some embodiments.

FIG. 4 is a flow diagram of manager enclave initialization processing according to some embodiments.

FIG. 5 is a flow diagram of private enclave initialization processing according to some embodiments.

FIG. 6 is a flow diagram of security processing during a deployment phase according to some embodiments.

FIG. 7 is a schematic diagram of an illustrative electronic computing device to perform security processing according to some embodiments.

### DETAILED DESCRIPTION

Implementations of the technology described herein provide a method and system that protects secret processing and secret input data used by the secret processing to generate secret output data when the secret processing is controlled by a secret processing owner, the secret input data is controlled by a data owner, and the secret output data is encrypted by an agent (implemented as a manager enclave herein) trusted by both data owner and the trusted third party. The encrypted secret output data is then used by a user in an isolated manner.

In an embodiment, the secret processing includes a machine learning (ML) model, a deep learning (DL) model, or an artificial intelligence (AI) process, the secret input data includes one or more data sets to train the ML model, DL model or AI process, and the secret output data includes parameters associated with the secret processing. In other embodiments, secret processing may include any data processing that a processing owner desires to keep secret from a data owner or users, secret output data may include any data generated by performing the secret processing, and secret input data may include any data used by the secret processing that a data owner desires to keep secret from the secret processing owner and users.

In embodiments, the secret input data is under the control of a data owner, rather than an owner of the secret processing. Additionally, the secret input data is encrypted by the data owner, while the secret processing owner can only process the secret input data by the secret processing in a secure environment authorized by the data owner or the TTP. The secret processing owner is deterred from accessing the secret input data in plaintext form. At the same time, neither the data owner nor the TTP can access the processing details (e.g., the algorithm) embodied in the secret processing. Only the secret processing owner can access the processing details of the secret processing. Any other user cannot access the secret input data, or the details of the secret processing and the secret output data (e.g., model parameters).

Embodiments provide deterrence of information leakage of the secret input data and protection of the secret processing and secret output data. In an embodiment, a computing arrangement includes three secure enclaves and a TTP. The three secure enclaves include a manager enclave (ME), a private enclave (PRE), and a public enclave (PUE). The TTP manages cryptographic keys and permission information for the enclaves, the secret processing owner, the data owner, and users.

In an embodiment, a secure enclave (also called an enclave herein) may be implemented in a computing system using software guard extensions (SGX), available from Intel Corporation. SGX technology may be used by application developers seeking to protect selected code (such as an algorithm embodied in code) and/or data (such as secret input data and/or secret output data) from disclosure or modification. SGX allows user-level code to allocate private regions of memory, called enclaves, which are designed to be protected from processes running at higher privilege levels. By using one or more SGX-based hardware trusted execution environments (TEEs), the secret processing process details can be protected while the secret input data is also protected. This expands the possible use cases for SGX and provides alternative solutions for multi-party computation (MPC) and homomorphic encryption (HE) scenarios.

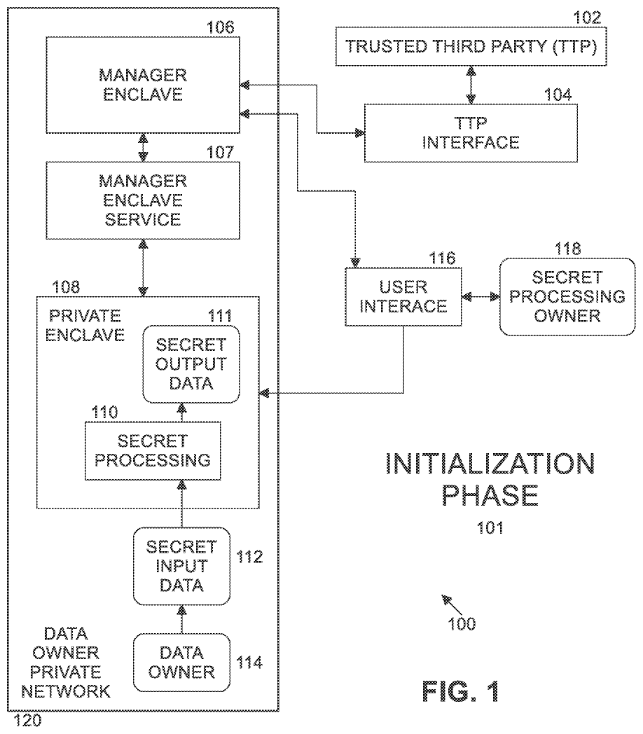

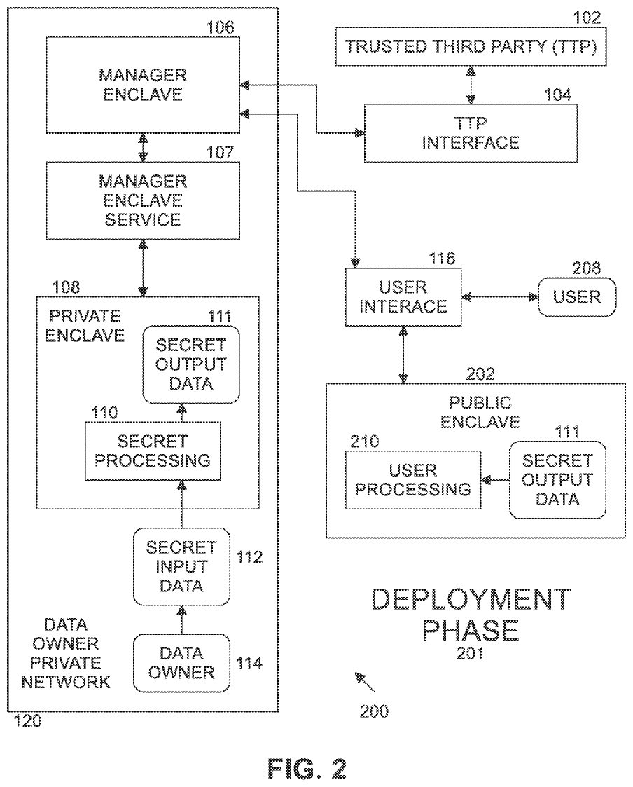

FIG. 1 is a diagram of a computing arrangement 100 during an initialization phase 101 according to some embodiments. FIG. 2 is a diagram of a computing arrangement during a deployment phase 201 according to some embodiments.

Processes implemented in secret processing (such as ML model training. DL model training, and/or AI processes) can generally be divided into two phases: an initialization phase 101 and a deployment phase 201. The initialization phase 101 should be kept secret while the deployment phase 201 can be used by the public. One example of this is a neural network algorithm in an AI process or model where the topography of the network (e.g., the model) is freely available to the public, while the weights of edges within the network (e.g., secret output data) may be kept secret since it usually takes a large amount of computing resources to get a neural network algorithm to converge. Another example is some decision tree methods, where a pruning method is developed by an algorithm owner and the inference process implementation straightforward once the decision tree is built.

During the enclave initialization phase, each enclave also has the capabilities to automatically generate an asymmetric key pair. The private key is called an enclave signature key. The public key can be used as an enclave ID to represent a specific enclave. The enclave can maintain its signature key (private key) for signing by using the SGX seal data function (in one embodiment), and publish the public key to outside parties, including the TTP for identification of a specific enclave instance.

Each enclave can further generate a second key pair (called encryption public key and encryption private key) for encryption purposes, so that the encryption public key can be used by other enclaves to perform encryption. The encrypted data can then be decrypted inside this specific enclave by using the encryption private key.

Accordingly, in the technology described herein, secret processing 110 code and resulting secret output data 111 are placed in a private enclave 108, where access to sensitive data (e.g., secret input data 112) may be needed to execute the secret processing. A user processing 210 deployment is placed in a public enclave 202, where auditing or review of the source code of the user processing is allowed. User processing 210 may read secret output data 111 only within public enclave 202. In an embodiment, private enclave 108 is placed within a data owner private network 120, which belongs to data owner 114, to restrict communication between secret processing 110 and the outside world, while the public enclave 202 is publicly deployed for access by users 208 for user processing 210 (e.g., inferencing processing by running a ML model, DL model or AI process using the user's data and secret output data 111 (such as model parameters, for example)).

A manager enclave (ME) 106 is used to represent the trusted agent and protect the privacy of secret input data 112, secret processing 110 and secret output data 111 during the entire processing lifecycle. Secret processing 110 and secret output data 111 are encrypted before being sent out from private enclave 108 and stored by a TTP 102 (e.g., on a storage service), and an encrypted key (used to encrypt secret processing 110 and/or secret output data 111) is handled by manager enclave 106. Each time a user 208 wants to make use of secret output data 111 by applying this data to user processing 210 inside public enclave 202, the user 208 and the secret output data must first pass a validation by manager enclave 106.

Private enclave 108 is placed within data owner private network 120 inaccessible to the outside world (e.g., users 208 of public enclave 202 or others) to prevent the private enclave from leaking sensitive data (e.g., secret input data 112) directly to secret processing owner 118 or others. The communications of private enclave 108 are limited by manager enclave 106 through manager enclave service 107. Thus, the ME provides an interface to data owner private network 120 to receive requests from private enclave 108. Additionally, user interface 116 is provided to a public network (such as the Internet), so that the end users (e.g., users 208) can load encrypted secret output data 111 into public enclave 202 through the manager enclave 106. Since manager enclave 106 and private enclave 108 cannot communicate directly with each other, manager enclave service 107 provides an interface between these enclaves.

A trusted third party (TTP) 102 communicates with manager enclave 106 over a TTP interface 104. In cryptography, a TTP is an entity (such as a certificate authority (CA)) which facilitates interactions between two parties who both trust the third party to perform certain services.

In an embodiment, TTP 102 implements a blockchain to store secret processing 110. secret output data 111 and the registration part (usually known as hash) of secret input data 112. A blockchain is a type of database that collects information together in groups, also known as blocks, that hold sets of information. Blocks have certain storage capacities and, when filled, are chained onto the previously filled block, forming a chain of data known as the “blockchain.” All new information that follows that freshly added block is compiled into a newly formed block that will then also be added to the chain once filled. Thus, a blockchain structures data into chunks (blocks) that are chained together. The blockchain also inherently makes an irreversible timeline of data when implemented in a decentralized nature. When a block is added to the blockchain, the block is fixed and becomes a part of the timeline. Each block in the chain is given an exact timestamp when the block is added to the chain.

Manager enclave 106 is executed within a private network or private computing environment operated by data owner 114. This data owner private network 120 is isolated from other computer networks (such as the Internet or other local area networks (LANs). Data owner 114 provides secret input data 112 to secret processing 110 operating within private enclave 108. Private enclave 108 is also executed within data owner private network 120. Secret processing owner 118 interacts with secret processing 110 in private enclave 108 via manager enclave 106 and user interface 116.

Thus, there are at least three different parties in this secure computing arrangement: secret processing owner 118 (SPO), data owner 114 (DO), and TTP 102. Generally, secret processing owner 118 encrypts and signs private enclave 108 (having secret processing 110), and TTP 102 signs manager enclave 106 for performing permission management tasks. Both signed encrypted private enclave 108 and signed manager enclave 106 are sent to data owner 114. Data owner 114 then deploys private enclave 108 and manager enclave 106 to data owner private network 120 (such as a local computing cluster) and starts secret processing 110 using secret input data 112 to produce secret output data 111. Once the secret processing finishes, private enclave 108 sends the encrypted secret output data 111 to manager enclave 106. Manager enclave 106 then uses a persistent symmetric session key to encrypt secret output data 111 to TTP 102.

Data owner 114 signs public enclave 202 for operation of user processing 210 deployment and sends public enclave 202 to the TTP 102 as well. A user 208 communicates with user interface 116 through manager enclave 106 to securely run user processing 210 (using secret output data 111) in public enclave 202.

The relationship among different parties and enclaves is summarized in Table 1.

TABLE 1

| Enclave | Signed by | Deployed at | Description |
|---|---|---|---|
| Public | DO | Computing | To perform the user deployment |
| enclave | | devices | using secret output data generated |
| | | of users | by the private enclave. |
| Private | Secret | DO | To run secret processing to |
| enclave | Processing | | generate secret output data. |
| | Owner | | |
| Manager | TTP | DO | To validate the secret output |
| enclave | | | data generated by the private |
| | | | enclave and upload to the TTP. |

In an embodiment, secret processing 110 is performed within the private enclave (PRE) and treated as secret, which comprises a set of codes and/or training scripts. Since the set of codes and training scripts are defined by the secret processing owner, no matter whether the codes have some common training frameworks (such as TensorFlow (an open source machine learning software library) or Pytorch (an open source machine learning software library based on the Torch library for computer vision and natural language processing applications, etc.)), they are still considered as secrets, including training scripts. Training scripts may include instructions such input/output (I/O) operations and a combination of code flow, weights, and parameter values (which may also be considered as secret).

In an embodiment, secret processing 110 is included into an enclave package. In an embodiment, “Enabling Enclave Code Confidentiality” from a SGX feature called Protected Code Loader (PCL thereafter) may be used to protect it. Once secret processing (e.g., model training) is complete, secret output data 111 resulting from secret processing may include trained model parameters (such as csv files, vectors, etc.).

To aid in understanding the following description. Table 2 lists cryptographic keys used herein.

TABLE 2

| | Asymmetric | | |
|---|---|---|---|
| Key | or Symmetric | Generated by | Use |
| Signature key | Asymmetric | Each | Enclave identifier (ID)(public), |
| | | individual | signing (private) |
| | | enclave | |
| Encryption | Asymmetric | Each | For others to encrypt short credentials |
| private/ | | individual | such as ephemeral key, persistent key, |
| public key | | enclave | and deployment session key, because |
| | | | this is based on asymmetric cryptographic |
| | | | algorithms and inefficient for large |
| | | | size message encryption such as secret |
| | | | output data. |
| Ephemeral | Symmetric | Private | Private enclave to encrypt secret |
| key | | enclave | output data before sending to manager |
| | | | enclave |
| Persistent | Symmetric | Manage | Manager enclave to encrypt secret |
| key | | enclave | output data before sending to TTP |
| Deployment | Symmetric | Manager | Manager enclave to encrypt secret output |
| session key | | enclave | data before sending to public enclave |
| PCL key | Symmetric | SPO | Used by PCL technology or similar |
| | | | implementation to protect secret |
| | | | processing, especially secret processing |
| | | | codes, because secret processing owner |
| | | | needs a PCL key to encrypt a private |
| | | | enclave software distribution package. |
| | | | Secret processing owner sends PCL key |
| | | | to manager enclave, and manager enclave |
| | | | uses PCL procedure to interface with |
| | | | SGX capable physical computing devices |
| | | | located in data owner private network, |
| | | | so that SGX capable computing devices |
| | | | can use the PCL key to decrypt the private |
| | | | enclave in a secure manner to allow the |
| | | | private enclave to be deployed in the |
| | | | data owner private network. |
| Enclave | Asymmetric | Enclave | Used by trusted execution environment |
| Signing Key | | owners such | (TEE) software distribution mechanism |
| | | as SPO, DO, | for SGX. Software/Enclave owners use |
| | | and TTP | their enclave signing key to sign an |
| | | | enclave distribution package, so that |
| | | | SGX can validate whether the owner's |
| | | | enclave is allowed to be launched by SGX. |

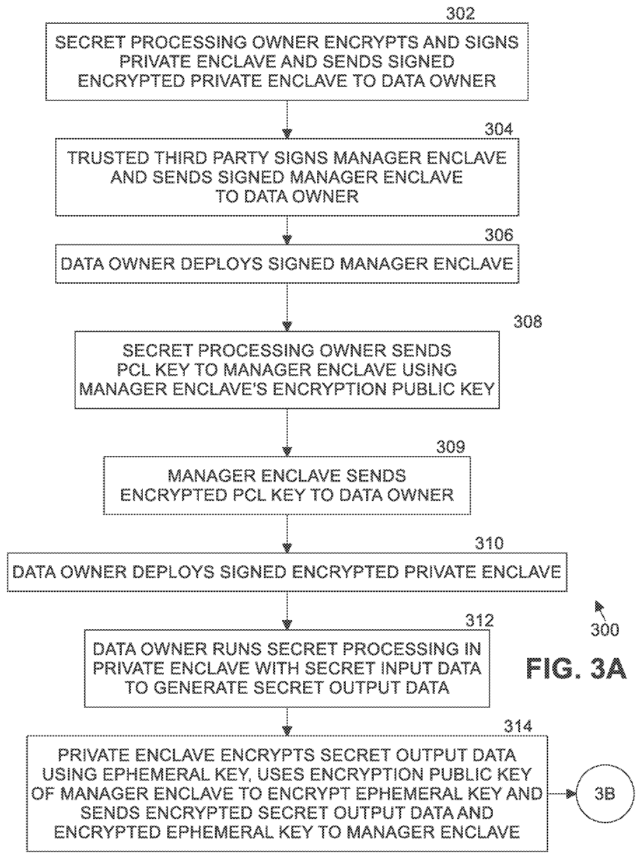

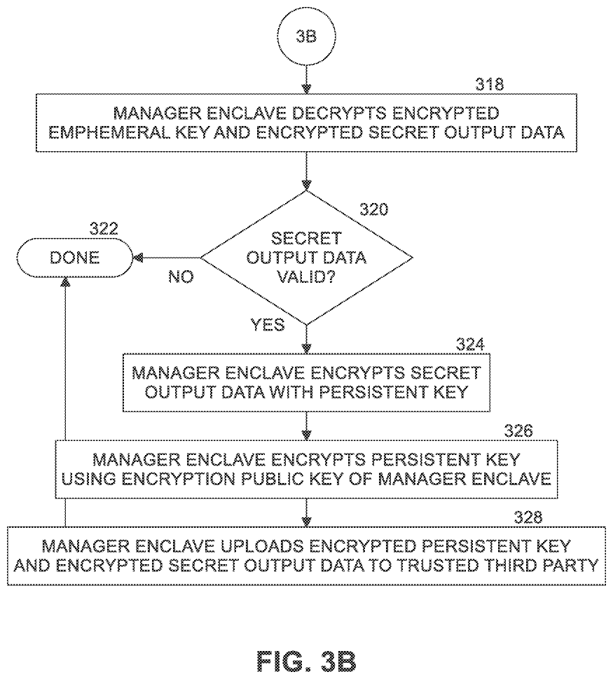

FIGS. 3A and 3B are flow diagrams of security processing 300 according to some embodiments. In an embodiment, a PCL key is a key generated by the secret processing owner 118, for the protected code loader (PCL) of Intel® SGX technology. At block 302, secret processing owner 118 encrypts private enclave 108 using the PCL key and signs the encrypted private enclave 108 using an enclave signing key of the secret processing owner and sends the signed encrypted private enclave to data owner 114. Private enclave 108 includes secret processing 110 (e.g., a model or algorithm) (which secret processing owner 118 desires to protect from unauthorized disclosure). At block 304, TTP 102 signs manager enclave 106 using the enclave signing key of the TTP and sends the signed manager enclave to data owner 114. At block 306, data owner 114 deploys the signed manager enclave. At block 308, secret processing owner 118 sends the encrypted PCL key to the manager enclave 106 using the manager enclave's encryption public key.

At block 309, the manager enclave sends the encrypted PCL key to target Intel® SGX capable computing devices that carry out the Intel® SGX PCL technology. At block 310, data owner 114 uses PCL technology to deploy signed encrypted private enclave 108, while keeping the secret processing 110 as secret to data owner 114. At block 312, data owner runs secret processing 110 in private enclave 108 with secret input data 112 to generate secret output data 111. At block 314, private enclave 108 encrypts secret output data 111 using an ephemeral key, uses the encryption public key of manager enclave 106 to encrypt the ephemeral key and sends the encrypted secret output data and encrypted ephemeral key to manager enclave 106.

Processing continues with block 318 of FIG. 3B. At block 318, once the manager enclave 106 receives the encrypted secret output data 111 and encrypted ephemeral key from the private enclave 108, manager enclave 106 decrypts the encrypted ephemeral key using the encryption private key of the manager enclave and decrypts the encrypted secret output data 111 using the decrypted ephemeral key. Manager enclave then validates the secret output data, to avoid the private enclave from inserting malicious data. At block 320, if the secret output data is invalid, then processing is complete at block 322. If the secret output data is valid, then at block 324 manager enclave 106 encrypts the secret output data with a new persistent key. In an embodiment, the persistent key is a symmetric key generated in the manager enclave. Note that the re-encrypt process is advantageous for data protection for the data owner 114, otherwise secret processing owner 118 could set a fixed ephemeral key in the private enclave that can be decrypted by the secret processing owner directly. In this scenario, it may be possible for the secret processing owner to access sensitive information from secret input data 112. At block 326, manager enclave 106 encrypts the persistent key with the encryption public key of the manager enclave. At block 328, manager enclave 106 uploads the encrypted persistent key and encrypted secret output data to TTP 102, and processing concludes at block 322. If secret processing owner 118 wants to use secret output data 111 within a public enclave 202, the secret processing owner needs to submit a request to TTP 102 like user 208.

TTP 102 now stores the encrypted secret output data 111, the persistent key that may be used to decrypt the encrypted secret output data, and the signed public enclave. User 208 may now be authenticated with TTP 102 via a request through user interface 116 and manager enclave 106 to in order to run user processing 210 deployment using secret output data 111 within public enclave 202.

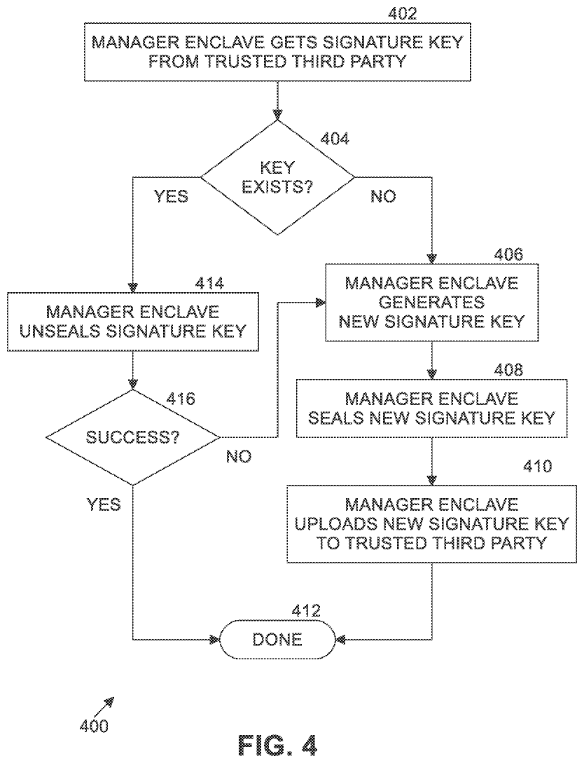

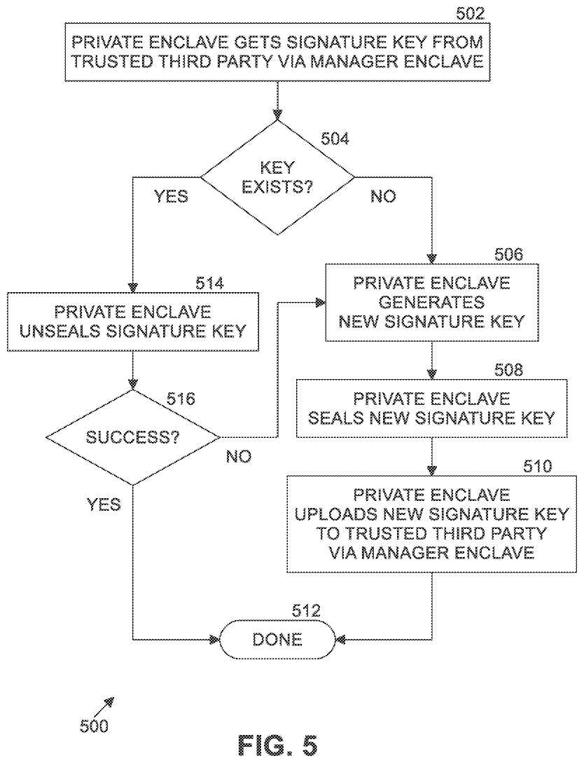

Manager enclave 106 holds a unique signature key to identify each instance of a manager enclave that is enabled in a specific private network of a specific data owner, and for specific processing (such as model training tasks). Similarly, private enclave 108 holds a unique signature key to identify each instance of a private enclave that is enabled in a specific private network of a specific data owner, and for specific processing (such as model training tasks). In one approach, each enclave randomly generates its own signature key for an instance of the enclave when an enclave starts up. However, this is a stateless method, meaning that the signature key will get changed after a restart of an enclave. This is not advantageous for some model training tasks. Additionally, manager enclave 106 and private enclave 108 need a method to restore their signature keys, and therefore retrieve and decrypt stored encrypted persistent keys and encrypted secret output data 111. Thus, a stateful enclave startup method may be used as described below in FIG. 4 and FIG. 5.

FIG. 4 is a flow diagram of manager enclave initialization processing 400 according to some embodiments. At block 402, manager enclave 106 gets a signature key for the manager enclave from TTP 102. In an embodiment, a public key of a signature key pair (the private signing key) may be used as an enclave ID to represent a specific enclave. At block 404, if the signature key exists (according to the TTP 102), then at block 414 manager enclave 106 unseals the signature key. At block 416, if signature key unsealing is a success, then manager enclave initialization processing is complete at block 412. If the signature key does not exist at block 404 or unsealing the signature key fails at block 414, then at block 406 manager enclave 106 randomly generates a new signature key. At block 408, manager enclave 106 seals the new signature key. In an embodiment, sealing may be performed as described in the Intel SGX Developer Guide, Revision 2.14 and later versions, June 2021. At block 410, manager enclave 106 uploads the new signature key to TTP 102, and processing is complete at block 412.

FIG. 5 is a flow diagram of private enclave initialization processing 500 according to some embodiments. At block 502, private enclave 108 gets a signature key for the private enclave from TTP 102 via manager enclave service 107 and manager enclave 106. At block 504, if the signature key exists (according to the TTP 102), then at block 514 private enclave 108 unseals the signature key. At block 516, if signature key unsealing is a success, then private enclave initialization processing is complete at block 512. If the signature key does not exist at block 504 or unsealing the signature key fails at block 514, then at block 506 private enclave 108 randomly generates a new signature key. At block 508, private enclave 108 seals the new signature key. At block 510, private enclave 108 uploads the new signature key to TTP 102 via manager enclave service 107 and manager enclave 106, and processing is complete at block 512.

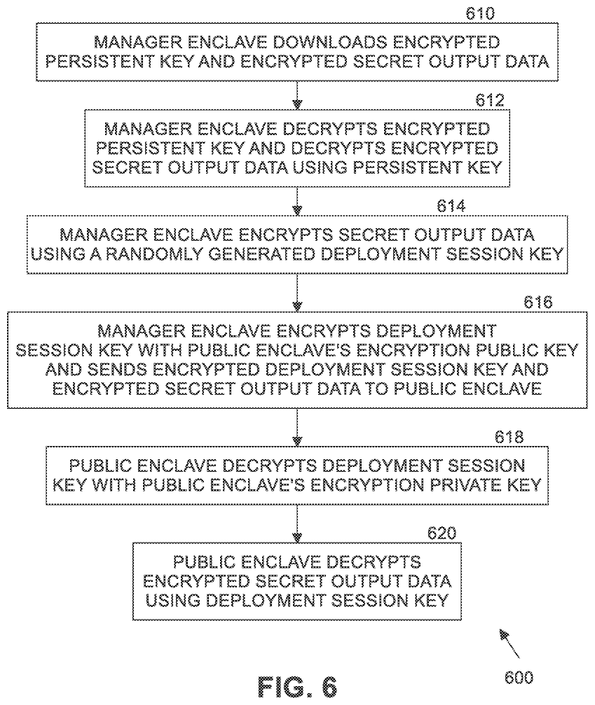

FIG. 6 is a flow diagram of security processing 600 during a deployment phase according to some embodiments. Once the encrypted secret output data 111 has been saved in the TTP 102, other users (e.g., user 208) are able to apply the secret output data to user processing 210 inside the public enclave 202 for deployment processing, but only if the public enclave passes authentication by manager enclave 106. This helps to deter unauthorized access to secret output data 111.

At block 610, manager enclave 106 downloads the encrypted persistent key and encrypted secret output data 111 from TTP 102. At block 612, manager enclave 106 decrypts the encrypted persistent key using the manager enclave's private key and decrypts the encrypted secret output data using the persistent key. At block 614, manager enclave 106 encrypts secret output data 111 using a randomly generated deployment session key. At block 616, manager enclave 106 encrypts the deployment session key with the public enclave's encryption public key and sends the encrypted deployment session key and the encrypted secret output data to public enclave 202. At block 618, the public enclave decrypts the encrypted deployment session key with the public enclave's encryption private key. At block 620, the public enclave decrypts the encrypted secret output data using the deployment session key. The secret output data may then be read by user processing 210 to perform processing while in public enclave 202.

Thus, embodiments provide for the capability of protecting secret input data for the data owner, protecting the secret processing for the secret processing owner, and protecting the secret output data from disclosure by the data owner, secret processing owner, and user.

Machine learning in an example application of the technology described herein, but other applications are contemplated. Any processing that uses a secret algorithm to compute over secret input data and generates secret output data may employ the present technology. This may include a training phase, or more generally, processing as simple as a data query or calculation. The secret output data may be used in a protected manner in user processing per a user's request. For example, assume the calculation of the sum of number three and four. The calculation is called the secret processing 110 (e.g., algorithm). The numbers three and four are the secret input data 112. The sum is the secret output data 111, which in this case is seven. As described herein, the secret output data value of seven is encrypted to the TTP, so no one knows the value. Later, in a deployment stage, in one example the user requests to evaluate whether the sum exceeds a threshold, for example, the number 10. The encrypted secret output data is sent to public enclave 202. Inside the public enclave, the secret output data is decrypted and compared to the threshold (e.g., by user processing 210). In this case, the result is negative. Therefore, the user gets the result that the sum does not exceed the threshold, but the user does not know the exact value, the data owner does not know the algorithm (e.g., the equation sum=a+b) or the secret output data (the sum value=7), the secret processing owner does not know the secret input data (a-3, b=4) or the secret output data (e.g., 7), and the user knows nothing but the query result (e.g., negative).

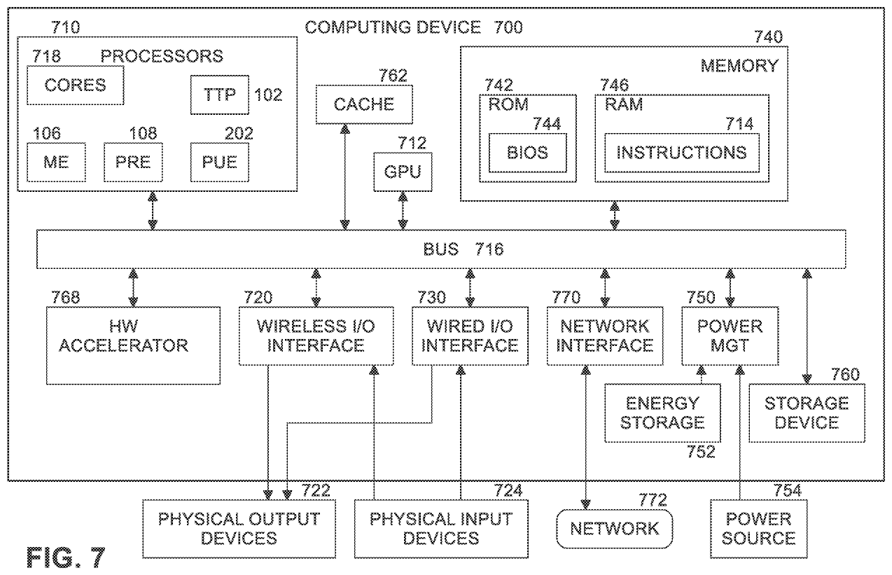

FIG. 7 is a schematic diagram of an illustrative electronic computing device to perform security processing according to some embodiments. In some embodiments, computing device 700 includes one or more processors 710 including one or more processor cores 718, and one or more of manager enclave 106 (ME), private enclave 108 (PRE), public enclave 202 (PUE), and trusted third party 102 (TTP). In some embodiments, the computing device 700 includes one or more hardware accelerators 768.

In some embodiments, the computing device is to implement security processing, as provided in FIGS. 1-6 above.

The computing device 700 may additionally include one or more of the following: cache 762, a graphical processing unit (GPU) 712 (which may be the hardware accelerator in some implementations), a wireless input/output (I/O) interface 720, a wired I/O interface 730, system memory 740, power management circuitry 780, non-transitory storage device 760, and a network interface 770 for connection to a network 772. The following discussion provides a brief, general description of the components forming the illustrative computing device 700. Example, non-limiting computing devices 700 may include a desktop computing device, blade server device, workstation, laptop computer, mobile phone, tablet computer, personal digital assistant, or similar device or system.

In embodiments, the processor cores 718 are capable of executing machine-readable instruction sets 714, reading data and/or machine-readable instruction sets 714 from one or more storage devices 760 and writing data to the one or more storage devices 760. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like. For example, machine-readable instruction sets 714 may include instructions to implement security processing, as provided in FIGS. 1-6.

The processor cores 718 may include any number of hardwired or configurable circuits, some or all of which may include programmable and/or configurable combinations of electronic components, semiconductor devices, and/or logic elements that are disposed partially or wholly in a PC, server, mobile phone, tablet computer, or other computing system capable of executing processor-readable instructions.

The computing device 700 includes a bus 716 or similar communications link that communicably couples and facilitates the exchange of information and/or data between various system components including the processor cores 718, the cache 762, the graphics processor circuitry 712, one or more wireless I/O interface 720, one or more wired I/O interfaces 730, one or more storage devices 760, and/or one or more network interfaces 770. The computing device 700 may be referred to in the singular herein, but this is not intended to limit the embodiments to a single computing device 700, since in certain embodiments, there may be more than one computing device 700 that incorporates, includes, or contains any number of communicably coupled, collocated, or remote networked circuits or devices.

The processor cores 718 may include any number, type, or combination of currently available or future developed devices capable of executing machine-readable instruction sets.

The processor cores 718 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 7 are of conventional design. Consequently, such blocks need not be described in further detail herein, as they will be understood by those skilled in the relevant art. The bus 716 that interconnects at least some of the components of the computing device 700 may employ any currently available or future developed serial or parallel bus structures or architectures.

The system memory 740 may include read-only memory (“ROM”) 742 and random-access memory (“RAM”) 746. A portion of the ROM 742 may be used to store or otherwise retain a basic input/output system (“BIOS”) 744. The BIOS 744 provides basic functionality to the computing device 700, for example by causing the processor cores 718 to load and/or execute one or more machine-readable instruction sets 714. In embodiments, at least some of the one or more machine-readable instruction sets 714 cause at least a portion of the processor cores 718 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 700 may include at least one wireless input/output (I/O) interface 720. The at least one wireless I/O interface 720 may be communicably coupled to one or more physical output devices 722 (tactile devices, video displays, audio output devices, hardcopy output devices, etc.). The at least one wireless I/O interface 720 may communicably couple to one or more physical input devices 724 (pointing devices, touchscreens, keyboards, tactile devices, etc.). The at least one wireless I/O interface 720 may include any currently available or future developed wireless I/O interface. Example wireless I/O interfaces include, but are not limited to: BLUETOOTH®, near field communication (NFC), and similar.

The computing device 700 may include one or more wired input/output (I/O) interfaces 730. The at least one wired I/O interface 730 may be communicably coupled to one or more physical output devices 722 (tactile devices, video displays, audio output devices, hardcopy output devices, etc.). The at least one wired I/O interface 730 may be communicably coupled to one or more physical input devices 724 (pointing devices, touchscreens, keyboards, tactile devices, etc.). The wired I/O interface 730 may include any currently available or future developed I/O interface. Example wired I/O interfaces include but are not limited to universal serial bus (USB), IEEE 1394 (“FireWire”), and similar.

The computing device 700 may include one or more communicably coupled, non-transitory, storage devices 760. The storage devices 760 may include one or more hard disk drives (HDDs) and/or one or more solid-state storage devices (SSDs). The one or more storage devices 760 may include any current or future developed storage appliances, network storage devices, and/or systems. Non-limiting examples of such storage devices 760 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more storage devices 760 may include one or more removable storage devices, such as one or more flash drives, flash memories, flash storage units, or similar appliances or devices capable of communicable coupling to and decoupling from the computing device 700.

The one or more storage devices 760 may include interfaces or controllers (not shown) communicatively coupling the respective storage device or system to the bus 716. The one or more storage devices 760 may store, retain, or otherwise contain machine-readable instruction sets, data structures, program modules, data stores, databases, logical structures, and/or other data useful to the processor cores 718 and/or graphics processor circuitry 712 and/or one or more applications executed on or by the processor cores 718 and/or graphics processor circuitry 712. In some instances, one or more data storage devices 760 may be communicably coupled to the processor cores 718, for example via the bus 716 or via one or more wired communications interfaces 730 (e.g., Universal Serial Bus or USB); one or more wireless communications interface 720 (e.g., Bluetooth®, Near Field Communication or NFC); and/or one or more network interfaces 770 (IEEE 802.3 or Ethernet, IEEE 802.11, or Wi-Fi®, etc.).

Machine-readable instruction sets 714 and other programs, applications, logic sets, and/or modules may be stored in whole or in part in the system memory 740. Such machine-readable instruction sets 714 may be transferred, in whole or in part, from the one or more storage devices 760. The machine-readable instruction sets 714 may be loaded, stored, or otherwise retained in system memory 740, in whole or in part, during execution by the processor cores 718 and/or graphics processor circuitry 712.

The computing device 700 may include power management circuitry 780 that controls one or more operational aspects of the energy storage device 782. In embodiments, the energy storage device 782 may include one or more primary (i.e., non-rechargeable) or secondary (i.e., rechargeable) batteries or similar energy storage devices. In embodiments, the energy storage device 782 may include one or more supercapacitors or ultracapacitors. In embodiments, the power management circuitry 780 may alter, adjust, or control the flow of energy from an external power source 784 to the energy storage device 782 and/or to the computing device 700. The external power source 784 may include, but is not limited to, a solar power system, a commercial electric grid, a portable generator, an external energy storage device, or any combination thereof.

For convenience, the processor cores 718, the graphics processor circuitry 712, the wireless I/O interface 720, the wired I/O interface 730, the storage device 760, and the network interface 770 are illustrated as communicatively coupled to each other via the bus 716, thereby providing connectivity between the above-described components. In alternative embodiments, the above-described components may be communicatively coupled in a different manner than illustrated in FIG. 7. For example, one or more of the above-described components may be directly coupled to other components, or may be coupled to each other, via one or more intermediary components (not shown). In another example, one or more of the above-described components may be integrated into the processor cores 718 and/or the graphics processor circuitry 712. In some embodiments, all or a portion of the bus 716 may be omitted and the components are coupled directly to each other using suitable wired or wireless connections.

Flowcharts representative of example hardware logic, machine readable instructions, hardware implemented state machines, and/or any combination thereof for implementing computing device 700, for example, are shown in FIGS. 3-6. The machine-readable instructions may be one or more executable programs or portion(s) of an executable program for execution by a computer processor such as the processor 710 shown in the example computing device 700 discussed above in connection with FIG. 7. The program may be embodied in software stored on a non-transitory computer readable storage medium such as a CD-ROM, a floppy disk, a hard drive, a DVD, a Blu-ray disk, or a memory associated with the processor 710, but the entire program and/or parts thereof could alternatively be executed by a device other than the processor 710 and/or embodied in firmware or dedicated hardware. Further, although the example program is described with reference to the flowcharts illustrated in FIGS. 3-6, many other methods of implementing the example computing device 700 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3-7 may be implemented using executable instructions (e.g., computer and/or machine-readable instructions) stored on a non-transitory computer and/or machine-readable medium such as a hard disk drive, a solid-state storage device (SSD), a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments. Example 1 is a method of receiving a signed private enclave from a secret processing owner; receiving a signed manager enclave from a trusted third party (TTP); deploying the signed manager enclave; receiving a protected code loader (PCL) key encrypted with an encryption public key of the signed manager enclave from the secret processing owner; deploying the signed private enclave; running secret processing in the signed private enclave with secret input data to generate secret output data; and encrypting the secret output data in the signed private enclave using an ephemeral key, encrypting the ephemeral key in the signed private enclave using an encryption public key of the signed manager enclave, and sending the encrypted secret output data and the encrypted ephemeral key to the signed manager enclave.

In Example 2, the subject matter of Example 1 can optionally include decrypting the encrypted ephemeral key in the signed manager enclave using the encryption private key of the signed manage enclave and decrypting the encrypted secret output data in the signed manager enclave using the ephemeral key; and when the secret output data is valid, encrypting the secret output data in the signed manager enclave using a persistent key, encrypting the persistent key in the signed manager enclave using the encryption public key of the signed manager enclave, and uploading the encrypted persistent key and the encrypted secret output data to the TTP.

In Example 3, the subject matter of Example 2 can optionally include downloading the encrypted persistent key and the encrypted secret output data from the TTP to the signed manager enclave; decrypting the encrypted persistent key inside the signed manager enclave using an encryption private key of the signed manager enclave and decrypting the encrypted secret output data inside the signed manager enclave using the persistent key; encrypting the secret output data inside the signed manager enclave using a randomly generated deployment session key; and encrypting the randomly generated deployment session key inside the signed manager enclave using an encryption public key of a public enclave and sending the encrypted randomly generated deployment session key and the encrypted secret output data to the public enclave.

In Example 4, the subject matter of Example 3 can optionally include decrypting the encrypted randomly generated deployment session key inside the public enclave with an encryption private key of the public enclave; and decrypting the encrypted secret output data inside the public enclave using the randomly generated deployment session key.

In Example 5, the subject matter of Example 4 can optionally include performing processing of the secret output data inside the public enclave.

In Example 6, the subject matter of Example 5 can optionally include wherein deploying the private enclave comprises deploying the private enclave within a private network inaccessible to users of the public enclave.

In Example 7, the subject matter of Example 1 can optionally include wherein the secret processing comprises at least one of machine learning model training, deep learning model training, and artificial intelligence process training.

In Example 8, the subject matter of Example 7 can optionally include wherein secret processing comprises training scripts.

Example 9 is at least one non-transitory machine-readable storage medium comprising instructions that, when executed, cause at least one processing device to receive a signed private enclave from a secret processing owner; receive a signed manager enclave from a trusted third party (TTP); deploy the signed manager enclave; receive a protected code loader (PCL) key encrypted with an encryption public key of the signed manager enclave from the secret processing owner; deploy the signed private enclave; run secret processing in the signed private enclave with secret input data to generate secret output data; and encrypt the secret output data in the signed private enclave using an ephemeral key, encrypt the ephemeral key in the signed private enclave using an encryption public key of the signed manager enclave, and send the encrypted secret output data and the encrypted ephemeral key to the signed manager enclave.

In Example 10, the subject matter of Example 9 can optionally include instructions that, when executed, cause at least one processing device to decrypt the encrypted ephemeral key in the signed manager enclave using the encryption private key of the signed manage enclave and decrypt the encrypted secret output data in the signed manager enclave using the ephemeral key; and when the secret output data is valid, encrypt the secret output data in the signed manager enclave using a persistent key, encrypt the persistent key in the signed manager enclave using the encryption public key of the signed manager enclave, and upload the encrypted persistent key and the encrypted secret output data to the TTP.

In Example 11, the subject matter of Example 10 can optionally. instructions that, when executed, cause at least one processing device to: download the encrypted persistent key and the encrypted secret output data from the TTP to the signed manager enclave; decrypt the encrypted persistent key inside the signed manager enclave using an encryption private key of the signed manager enclave and decrypt the encrypted secret output data inside the signed manager enclave using the persistent key; encrypt the secret output data inside the signed manager enclave using a randomly generated deployment session key; and encrypt the randomly generated deployment session key inside the signed manager enclave using an encryption public key of a public enclave and send the encrypted randomly generated deployment session key and the encrypted secret output data to the public enclave.

In Example 12, the subject matter of Example 11 can optionally include wherein instructions that, when executed, cause at least one processing device to: decrypt the encrypted randomly generated deployment session key inside the public enclave with an encryption private key of the public enclave; and decrypt the encrypted secret output data inside the public enclave using the randomly generated deployment session key.

In Example 13, the subject matter of Example 12 can optionally include instructions that, when executed, cause at least one processing device to perform processing of the secret output data inside the public enclave.

In Example 14, the subject matter of Example 13 can optionally include wherein deploying the private enclave comprises deploying the private enclave within a private network inaccessible to users of the public enclave.

Example 15 is an apparatus comprising: a processor; and a memory coupled to the processor, the memory having instructions stored thereon that, in response to execution by the processor, cause the processor to: comprising receive a signed private enclave from a secret processing owner; receive a signed manager enclave from a trusted third party (TTP); deploy the signed manager enclave; receive a protected code loader (PCL) key encrypted with an encryption public key of the signed manager enclave from the secret processing owner; deploy the signed private enclave; run secret processing in the signed private enclave with secret input data to generate secret output data; and encrypt the secret output data in the signed private enclave using an ephemeral key, encrypt the ephemeral key in the signed private enclave using an encryption public key of the signed manager enclave, and send the encrypted secret output data and the encrypted ephemeral key to the signed manager enclave.

In Example 16, the subject matter of Example 15 can optionally include instructions that, when executed, cause the processor to decrypt the encrypted ephemeral key in the signed manager enclave using the encryption private key of the signed manage enclave and decrypt the encrypted secret output data in the signed manager enclave using the ephemeral key; and when the secret output data is valid, encrypt the secret output data in the signed manager enclave using a persistent key, encrypt the persistent key in the signed manager enclave using the encryption public key of the signed manager enclave, and upload the encrypted persistent key and the encrypted secret output data to the TTP.

In Example 17, the subject matter of Example 16 can optionally include. instructions that, when executed, cause the processor to download the encrypted persistent key and the encrypted secret output data from the TTP to the signed manager enclave; decrypt the encrypted persistent key inside the signed manager enclave using an encryption private key of the signed manager enclave and decrypt the encrypted secret output data inside the signed manager enclave using the persistent key; encrypt the secret output data inside the signed manager enclave using a randomly generated deployment session key; and encrypt the randomly generated deployment session key inside the signed manager enclave using an encryption public key of a public enclave and send the encrypted randomly generated deployment session key and the encrypted secret output data to the public enclave.

In Example 18, the subject matter of Example 17 can optionally include instructions that, when executed, cause the processor to decrypt the encrypted randomly generated deployment session key inside the public enclave with an encryption private key of the public enclave; and decrypt the encrypted secret output data inside the public enclave using the randomly generated deployment session key.

In Example 19, the subject matter of Example 18 can optionally include instructions that, when executed, cause the processor to perform processing of the secret output data inside the public enclave.

In Example 20, the subject matter of Example 19 can optionally include. wherein deploying the private enclave comprises deploying the private enclave within a private network inaccessible to users of the public enclave.

Example 21 is an apparatus comprising means for receiving a signed private enclave from a secret processing owner; means for receiving a signed manager enclave from a trusted third party (TTP); means for deploying the signed manager enclave; receiving a protected code loader (PCL) key encrypted with an encryption public key of the signed manager enclave from the secret processing owner; means for deploying the signed private enclave; means for running secret processing in the signed private enclave with secret input data to generate secret output data; and means for encrypting the secret output data in the signed private enclave using an ephemeral key, means for encrypting the ephemeral key in the signed private enclave using an encryption public key of the signed manager enclave, and means for sending the encrypted secret output data and the encrypted ephemeral key to the signed manager enclave.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. A method comprising:
receiving a signed private enclave from a secret processing owner;
receiving a signed manager enclave from a trusted third party (TTP);
deploying the signed manager enclave;
receiving a protected code loader (PCL) key encrypted with an encryption public key of the signed manager enclave from the secret processing owner;
deploying the signed private enclave;
running secret processing in the signed private enclave with secret input data to generate secret output data; and
encrypting the secret output data in the signed private enclave using an ephemeral key, encrypting the ephemeral key in the signed private enclave using an encryption public key of the signed manager enclave, and sending the encrypted secret output data and the encrypted ephemeral key to the signed manager enclave.

2. The method of claim 1, comprising:
decrypting the encrypted ephemeral key in the signed manager enclave using the encryption private key of the signed manage enclave and decrypting the encrypted secret output data in the signed manager enclave using the ephemeral key; and
when the secret output data is valid, encrypting the secret output data in the signed manager enclave using a persistent key, encrypting the persistent key in the signed manager enclave using the encryption public key of the signed manager enclave, and uploading the encrypted persistent key and the encrypted secret output data to the TTP.

3. The method of claim 2, comprising:
downloading the encrypted persistent key and the encrypted secret output data from the TTP to the signed manager enclave;
decrypting the encrypted persistent key inside the signed manager enclave using an encryption private key of the signed manager enclave and decrypting the encrypted secret output data inside the signed manager enclave using the persistent key;
encrypting the secret output data inside the signed manager enclave using a randomly generated deployment session key; and
encrypting the randomly generated deployment session key inside the signed manager enclave using an encryption public key of a public enclave and sending the encrypted randomly generated deployment session key and the encrypted secret output data to the public enclave.

4. The method of claim 3, comprising:
decrypting the encrypted randomly generated deployment session key inside the public enclave with an encryption private key of the public enclave; and
decrypting the encrypted secret output data inside the public enclave using the randomly generated deployment session key.

5. The method of claim 4, comprising:
performing processing of the secret output data inside the public enclave.

6. The method of claim 5, wherein deploying the private enclave comprises deploying the private enclave within a private network inaccessible to users of the public enclave.

7. The method of claim 1, wherein the secret processing comprises at least one of machine learning model training, deep learning model training, and artificial intelligence process training.

8. The method of claim 7, wherein secret processing comprises training scripts.

9. At least one non-transitory machine-readable storage medium comprising instructions that, when executed, cause at least one processing device to:
receive a signed private enclave from a secret processing owner;
receive a signed manager enclave from a trusted third party (TTP);
deploy the signed manager enclave;
receive a protected code loader (PCL) key encrypted with an encryption public key of the signed manager enclave from the secret processing owner;
deploy the signed private enclave;
run secret processing in the signed private enclave with secret input data to generate secret output data; and
encrypt the secret output data in the signed private enclave using an ephemeral key, encrypt the ephemeral key in the signed private enclave using an encryption public key of the signed manager enclave, and send the encrypted secret output data and the encrypted ephemeral key to the signed manager enclave.

10. The at least one non-transitory machine-readable storage medium of claim 9 comprising instructions that, when executed, cause at least one processing device to:
decrypt the encrypted ephemeral key in the signed manager enclave using the encryption private key of the signed manage enclave and decrypt the encrypted secret output data in the signed manager enclave using the ephemeral key; and
when the secret output data is valid, encrypt the secret output data in the signed manager enclave using a persistent key, encrypt the persistent key in the signed manager enclave using the encryption public key of the signed manager enclave, and upload the encrypted persistent key and the encrypted secret output data to the TTP.

11. The at least one non-transitory machine-readable storage medium of claim 10 comprising instructions that, when executed, cause at least one processing device to:
download the encrypted persistent key and the encrypted secret output data from the TTP to the signed manager enclave;
decrypt the encrypted persistent key inside the signed manager enclave using an encryption private key of the signed manager enclave and decrypt the encrypted secret output data inside the signed manager enclave using the persistent key;
encrypt the secret output data inside the signed manager enclave using a randomly generated deployment session key; and
encrypt the randomly generated deployment session key inside the signed manager enclave using an encryption public key of a public enclave and send the encrypted randomly generated deployment session key and the encrypted secret output data to the public enclave.

12. The at least one non-transitory machine-readable storage medium of claim 11 comprising instructions that, when executed, cause at least one processing device to:
decrypt the encrypted randomly generated deployment session key inside the public enclave with an encryption private key of the public enclave; and
decrypt the encrypted secret output data inside the public enclave using the randomly generated deployment session key.

13. The at least one non-transitory machine-readable storage medium of claim 12 comprising instructions that, when executed, cause at least one processing device to:
perform processing of the secret output data inside the public enclave.

14. The at least one non-transitory machine-readable storage medium of claim 13, wherein deploying the private enclave comprises deploying the private enclave within a private network inaccessible to users of the public enclave.

15. An apparatus comprising:
a processor; and
a memory coupled to the processor, the memory having instructions stored thereon that, in response to execution by the processor, cause the processor to:
receive a signed private enclave from a secret processing owner;
receive a signed manager enclave from a trusted third party (TTP);
deploy the signed manager enclave;
receive a protected code loader (PCL) key encrypted with an encryption public key of the signed manager enclave from the secret processing owner;
deploy the signed private enclave;
run secret processing in the signed private enclave with secret input data to generate secret output data; and
encrypt the secret output data in the signed private enclave using an ephemeral key, encrypt the ephemeral key in the signed private enclave using an encryption public key of the signed manager enclave, and send the encrypted secret output data and the encrypted ephemeral key to the signed manager enclave.

16. The apparatus of claim 15 comprising instructions that, when executed, cause the processor to:
decrypt the encrypted ephemeral key in the signed manager enclave using the encryption private key of the signed manage enclave and decrypt the encrypted secret output data in the signed manager enclave using the ephemeral key; and
when the secret output data is valid, encrypt the secret output data in the signed manager enclave using a persistent key, encrypt the persistent key in the signed manager enclave using the encryption public key of the signed manager enclave, and upload the encrypted persistent key and the encrypted secret output data to the TTP.

17. The apparatus of claim 16 comprising instructions that, when executed, cause the processor to:
download the encrypted persistent key and the encrypted secret output data from the TTP to the signed manager enclave;
decrypt the encrypted persistent key inside the signed manager enclave using an encryption private key of the signed manager enclave and decrypt the encrypted secret output data inside the signed manager enclave using the persistent key;
encrypt the secret output data inside the signed manager enclave using a randomly generated deployment session key; and
encrypt the randomly generated deployment session key inside the signed manager enclave using an encryption public key of a public enclave and send the encrypted randomly generated deployment session key and the encrypted secret output data to the public enclave.

18. The apparatus of claim 17 comprising instructions that, when executed, cause the processor to:
decrypt the encrypted randomly generated deployment session key inside the public enclave with an encryption private key of the public enclave; and
decrypt the encrypted secret output data inside the public enclave using the randomly generated deployment session key.

19. The apparatus of claim 18 comprising instructions that, when executed, cause the processor to perform processing of the secret output data inside the public enclave.

20. The apparatus of claim 19 wherein deploying the private enclave comprises deploying the private enclave within a private network inaccessible to users of the public enclave.
